(19) United States
(12) Patent Application Publication
(10) Pub. No.: US 2007/0250499 A1
(43) Pub. Date: Oct. 25, 2007

(54) Method and system for finding data objects within large data-object libraries

(76) Inventors: Simon Widdowson, Dublin, CA (US); Clayton Brian Atkins, Mountain View, CA (US); Ullas Gargi, San Jose, CA (US); Pere Obrador, Mountain View, CA (US)

Correspondence Address: HEWLETT-PACKARD COMPANY;Intellectual Property Administration, P.O. Box 272400, Fort Collins, CO, 80527-2400, US

(21) Appl. No.: 11/408,855

(22) Filed: Apr. 21, 2006

(51) Int. Cl. G06F 17/30

(52) U.S. Cl. 707/5

(57) ABSTRACT

Various embodiments of the present invention include a method for searching or browsing data objects within a data-object library. A current sub-population of data objects is initialized. The current sub-population contains data objects selected from the data-object library and defined by current data-object-selection criteria. Then, in a continuously iterating fashion, data objects are selected from the current sub-population and presented, and the current data-object-selection criteria are modified in order to modify the current sub-population of data objects from which data objects are subsequently selected for presentation, the modification elicited by input and automatically, by the grazing routine, following a period without input.

### TECHNICAL FIELD

The present invention is related to electronic-data storage and to electronic user interfaces and, in particular, provides method and system embodiments that allow human users to navigate a large library of data objects by directed browsing of a data-object presentation.

### BACKGROUND OF THE INVENTION

During the past 30 years, computer systems have evolved from relatively simple processing engines with limited memories and mass-storage capacities that primarily operated on alpha-numeric input, text files, and numeric data files to high-powered, multi-processor processing engines that access vast local memories and high-capacity local mass storage devices via internal buses as well as vast remote memories and extremely high-capacity mass storage devices via various types of external communications media. Modern computers are capable of storing, managing, and accessing terabytes and even petabytes of a wide variety of different types of digitally encoded data, including video and audio data, photographic images, text-based and numeric data, and many types of complex data objects generated, stored, managed, and retrieved by a variety of different data management applications and systems. Many modern data management systems provide various types of indexing and data-object-locating facilities. For example, attribute values for attributes associated with a data object can be assigned to the data object during or following storage of the data object, and query-based data-management and data-retrieval facilities provided by modern data management systems can locate data objects having attributes with attribute values that satisfy criteria expressed in attribute-value-based queries.

Unfortunately, the capacities of modern computer-based data-object storage, management, and retrieval systems often exceed the data-object location facilities provided by these systems. Attribute values may be constrained to relatively short text strings, integer values, and other primitives which lack the expressive power, flexibility, and natural-language capabilities needed by human users to classify data objects for storage, retrieval, and location.

As one example, it may be exceedingly difficult for a human user to formulate queries using relational-database query languages or other such simple, algebraic query languages in order to find one or a few photographic images within a large database containing hundreds of thousands of photographic images. The user would need to understand and remember the various types of attributes and attribute values that have been associated with photographic images within the database in order to formulate queries to find photographic images. Moreover, many of the queries that a user might want to make may require attributes and attribute values previously assigned to data objects with extremely high levels of foresight, and may involve very complex queries as well as procedural techniques for directly querying the content of photographic images.

As one example, a user may desire to find all photographic images within a library that include sub-images of a child between the ages of two and four playing with a beach ball. Although it is possible that a Boolean-valued attribute child_laying_with_a_beach_ball_included may have been associated with each photographic image, it is highly unlikely that attributes of such particularity would have been specified during photographic-image storage and characterization operations. In the case that titles have been stored for each photographic image, it might be possible to locate candidate photographic images by retrieving photographic images that include the phrase “beach ball” within the titles, but the list of photographic images satisfying that criterion would almost certainly be vastly over-inclusive as well as vastly under-inclusive. Many might, for example, include sub-images of beach balls without children, or with children outside the specified age range of 2-4. On the other hand, many images that do include the desired sub-image might have titles that do not include the phrase “beach ball,” such as “Aunt Alice's Big Day at the Beach.”

Alternatively, a procedure could be developed to electronically access a photographic image and search the image for sub-images of small children playing with beach balls. However, the cost to develop such procedures would be extremely high, development would require copious amounts of time and significant financial expenditure, and application of the procedure to all of the images in a large image database, or image library, would use prodigious amounts of processing cycles and processing time, resulting in impractical searches or searches that could simply not be performed, even with unlimited financial resources. The data-storage requirements for storing a sufficiently large number of such specialized procedures would generally be prohibitive, as well, and could easily exceed the data-storage used to store the photographic images.

Thus, current techniques by which human users can locate photographic images within photographic-image libraries, and other types of complex data objects within other types of complex-data-object libraries, are often inadequate. As ever increasingly complex software applications generate greater and greater amounts of data of ever increasing complexity, the need for better methods to allow users to locate particular data objects within large data-object libraries is rapidly increasing, and has been identified as a critical problem in a variety of fields, from database management systems and electronic-data archiving systems to management and processing of scientific data and development of internet search engines.

### SUMMARY OF THE INVENTION

Various embodiments of the present invention include a method for searching or browsing data objects within a data-object library. A current sub-population of data objects is initialized. The current sub-population contains data objects selected from the data-object library and defined by current data-object-selection criteria. Then, in a continuously iterating fashion, data objects are selected from the current sub-population and presented, and the current data-object-selection criteria are modified in order to modify the current sub-population of data objects from which data objects are subsequently selected for presentation, the modification elicited by input and automatically, by the grazing routine, following a period without input.

### BRIEF DESCRIPTION OF THE DRAWINGS

FIG. 1 illustrates the basic components of a large data-object-library search problem.

FIG. 2 illustrates the abstract, computational entities to which the problem domain illustrated in FIG. 1 is mapped by various method and system embodiments of the present invention.

FIG. 3 illustrates an exemplary data object and an exemplary user profile employed in certain embodiments of the present invention.

FIGS. 4A-E illustrate multi-dimensional data-object spaces and multi-dimensional-data-object-space searching.

FIGS. 5A-B illustrates 1-dimensional and 2-dimensional projections of the 3-dimensional sub-volume illustrated in FIG. 4D.

FIGS. 6A-F illustrate a photographic-image data-object presentation used in various photographic-image-based embodiments of the present invention.

FIGS. 7A-I illustrate changes in a current sub-population resulting from user input and from automatic data-object-selection-criteria relaxation due to user inactivity according to various embodiments of the present invention.

FIG. 8 shows a hierarchical classification scheme by which data objects may be classified.

FIGS. 9A-D illustrate typical user searches conducted by using various embodiments of the present invention.

FIGS. 10-11 provide control-flow diagrams for a grazing routine that represents one embodiment of the present invention.

### DETAILED DESCRIPTION OF THE INVENTION

Various method and system embodiments of the present invention provide both a user interface as well as intuitive data-object-library navigation and search facilities to allow human users to locate particular data objects of interest within large data-object databases or data-object libraries. These method and system embodiments of the present invention are particular useful for complex data objects that can be visually presented to a user, including data objects that represent photographic images, video clips, documents, and other complex data objects. However, the general method and system embodiments of the present invention can be applied to navigation and searching of a wide variety of different types of data-object libraries.

Various embodiments of the present invention include a grazing routine that selects data objects from a data-object library or database and provides the data objects to a presentation routine that uses the data objects to continuously update a data-object presentation. User input directs subsequent data-object selection by the grazing routine to allow users to intuitively navigate and search a large data-object library in order to locate one or a set of particular data objects. Users can input selection commands to specific presented data-objects in order to focus subsequent data-object selection and data-object presentation to increasingly smaller sub-populations of data objects. In the absence of user input, the sub-population of data objects from which data objects are selected for presentation may be incrementally increased. The grazing routine continuously updates the presentation, even without user input, so that a user is provided with a continuously changing presentation of data objects. User input can change the sub-population of data objects from which the grazing routine selects data objects for presentation to the user, and can also fix the current sub-population or sub-population size, so that the grazing routines continues to select data objects from a single sub-population or from sub-populations of the same size. But, regardless of whether or not a user interacts with the system, new data objects are continuously selected and presented by the grazing routine.

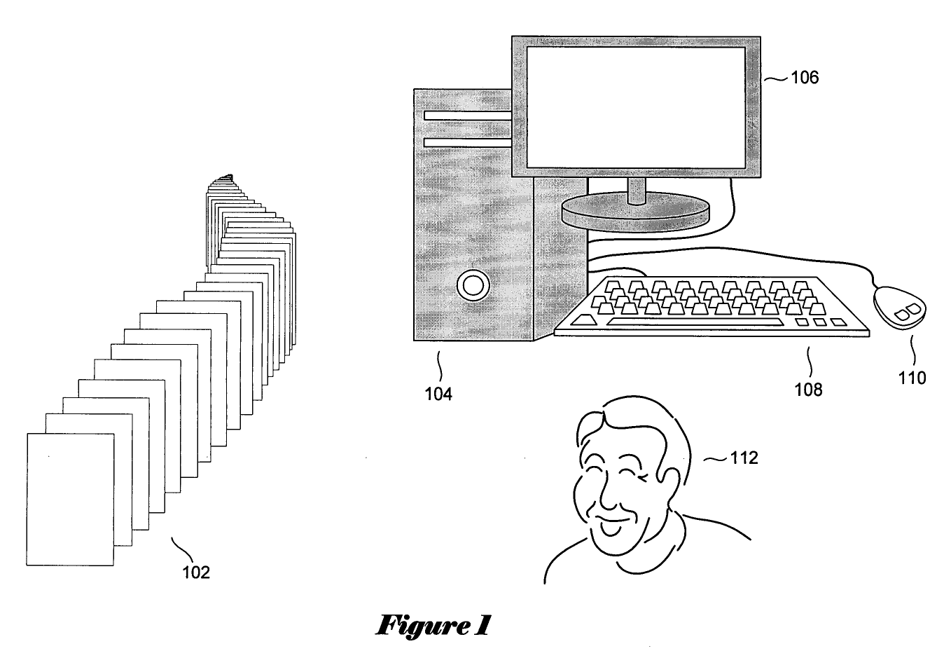

FIG. 1 illustrates the basic components of a large data-object library search problem. In the current discussion, an example is used, for purposes of describing the present invention, in which data objects are considered to be photographic images that are digitally encoded and electronically stored within an electronic-data storage system. For purposes of the current discussion, the library of photographic images 102 includes at least 1000 photographic images, and would generally include tens of thousands, hundreds of thousands, or greater numbers of photographic images. Photographic images can be accessed from the library via a computer system 104 and displayed for viewing by a human user on a display device 106 connected to the computer system. The computer system includes user input devices 108 and 110 that allow a human user to input image-retrieval criteria, to customize display of photographic images, and to select particular images or groups of images for various purposes, including storing in local directories, printing, or inputting to various types of software applications. A search of the image library 102 is conducted by a human user 112, who may be searching for particular images that the user recollects, who may be searching for particular categories of images that meet a criteria formulated by the user, or who may wish simply to peruse the image library in order to become familiar with the contents of the image library or carry out various types of research or knowledge-acquisition tasks.

It should be noted that there are a variety of different types of electronic-data storage systems for storing large data-object libraries, such as photographic-image libraries. A data-object library may be stored remotely from the user's computer system and accessed via any of various communications media and communications systems, may be stored in a collection of removable mass-storage devices accessible from the user's local computer, or may be stored within memory and mass-storage devices within, or directly connected to, the user's local computer. The particular electronic-data storage system employed to store the data-object library may provide various levels of attribute-based query searching, management, storage, and retrieval operations, and may also provide a variety of different data-object display facilities. However, as discussed in a previous subsection, such query-based searching, or index-based organizational tools, are often inadequate for users wishing to efficiently conduct a wide variety of natural-language-level, conceptual, data-object searches, such as finding photographic images that include a sub-image of a small child playing with a beach ball, as discussed above.

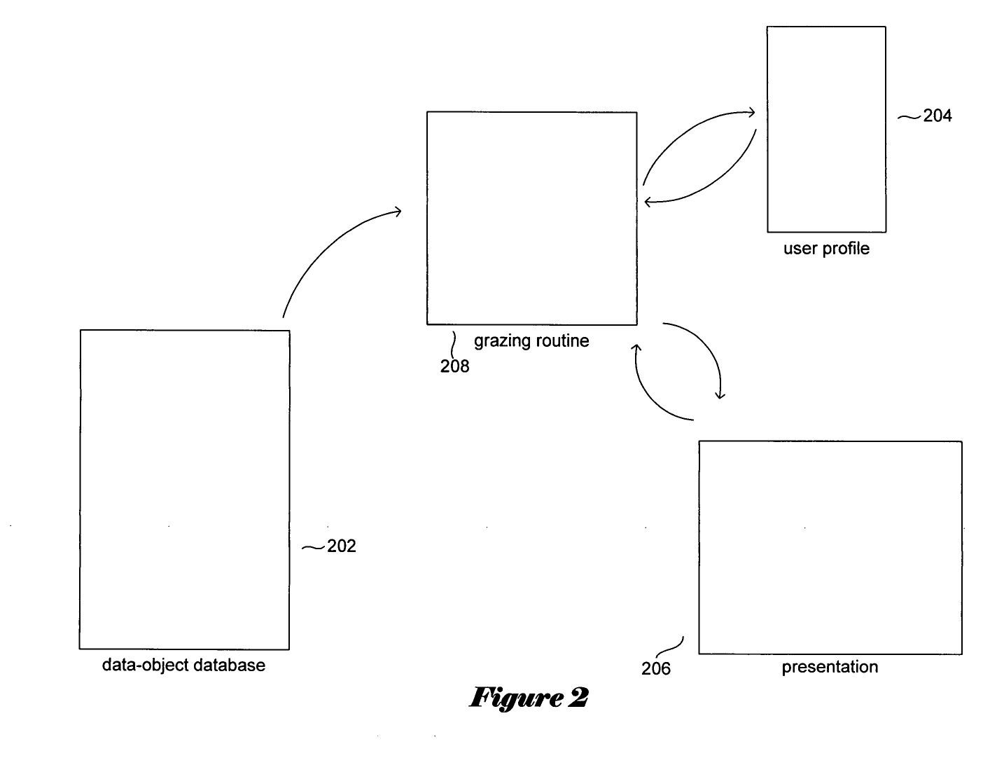

FIG. 2 illustrates the abstract, computational entities to which the problem domain illustrated in FIG. 1 is mapped by various method and system embodiments of the present invention. The data-object library (102 in FIG. 1) is mapped to an electronic data-object database 202 that generally provides well-defined storage, attribute-based searching, indexing, and retrieval operations. The human user (112 in FIG. 1) is characterized by a user profile 204, a digitally encoded data structure that stores general characteristics and attributes of a human user, various user preferences, and specific criteria relevant to a current search of the data-object database. The visual display device (106 in FIG. 1) and software applications controlling display or presentation of data objects is mapped to a presentation routine 206, discussed in greater detail below with respect to the photographic-image-library searching embodiment of the present invention. As discussed, audio devices and audio-device-controlling software may be used for data-objects more naturally and effectively presented as sound. Other types of presentation devices and controlling software are possible, including, for example, tactile devices for blind users. A grazing routine 208 implements various method embodiments of the present invention by controlling selection of data objects from the data-object database 202 for input to the presentation routine 206 to facilitate directed browsing and data-object searching by a user described by the contents of the user-profile data structure 204, and which receives inputs from a user that are passed to the grazing routine and used by the grazing routine to update the user profile 204 in order to direct data-object-library browsing or searching in accordance with the user's inputs.

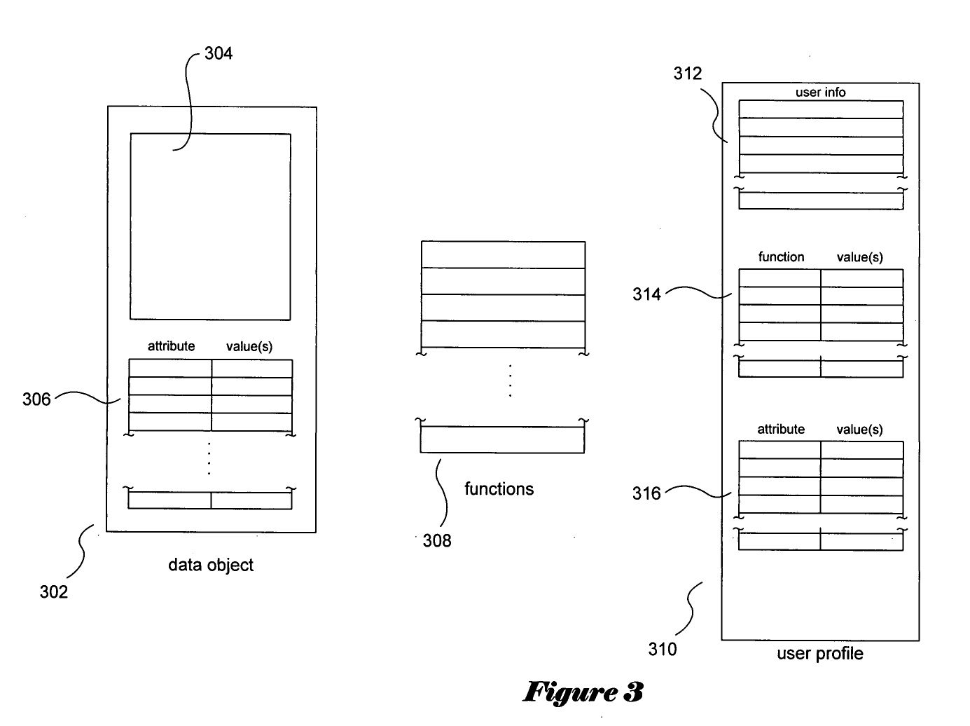

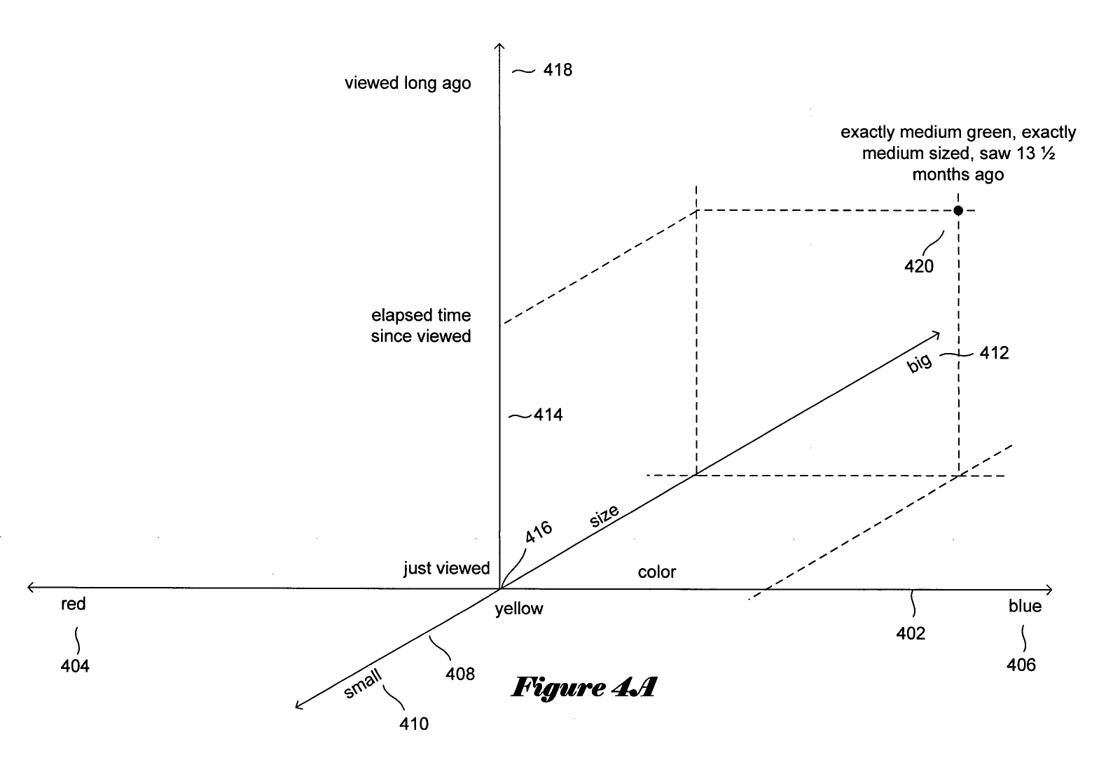

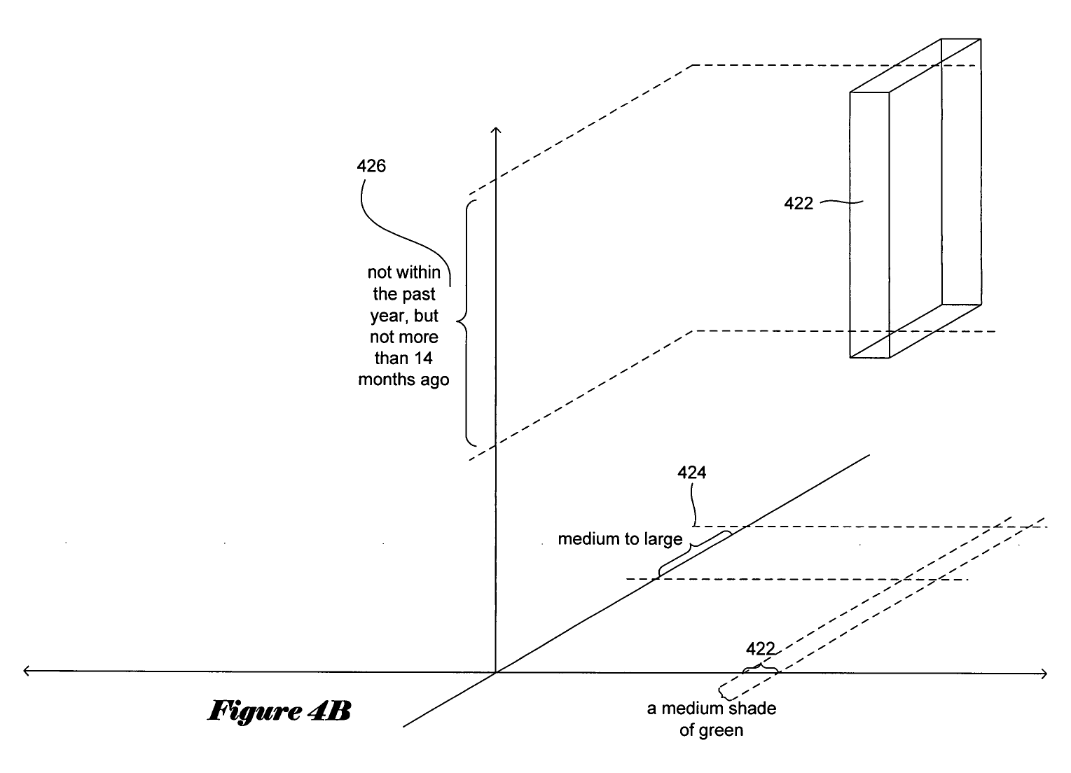

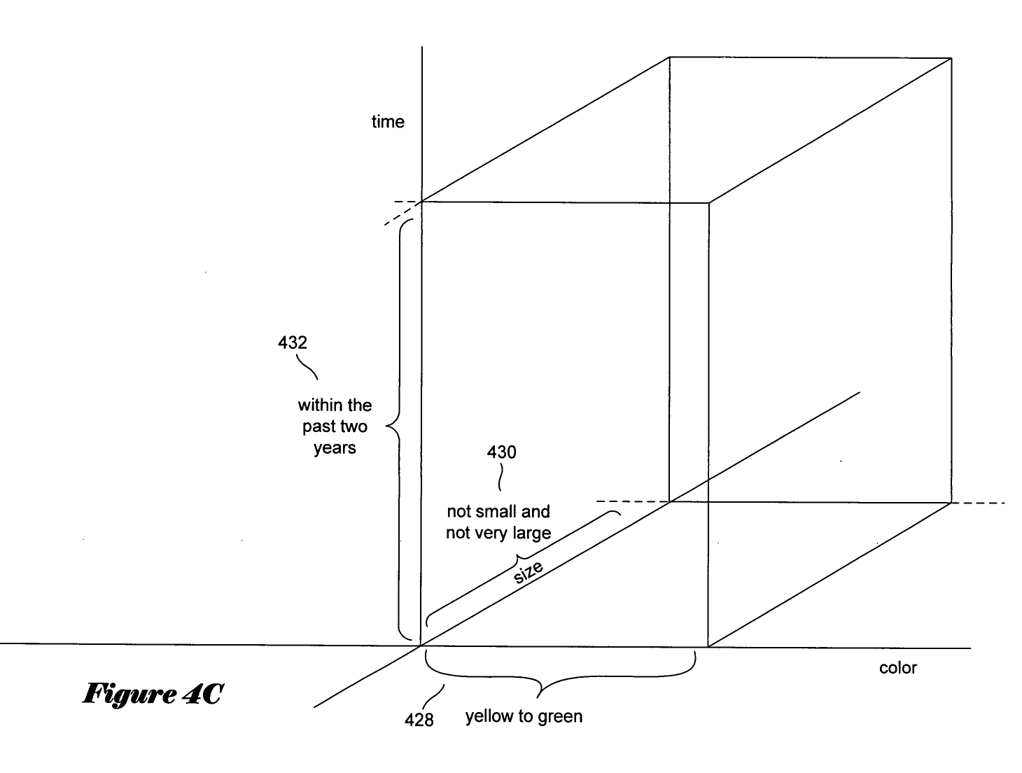

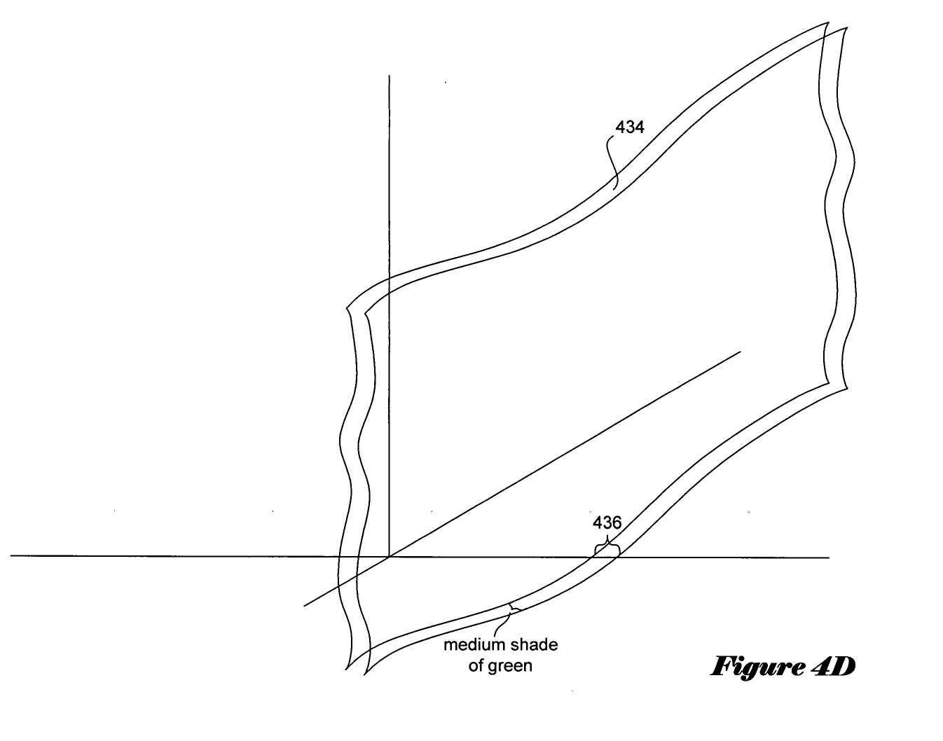

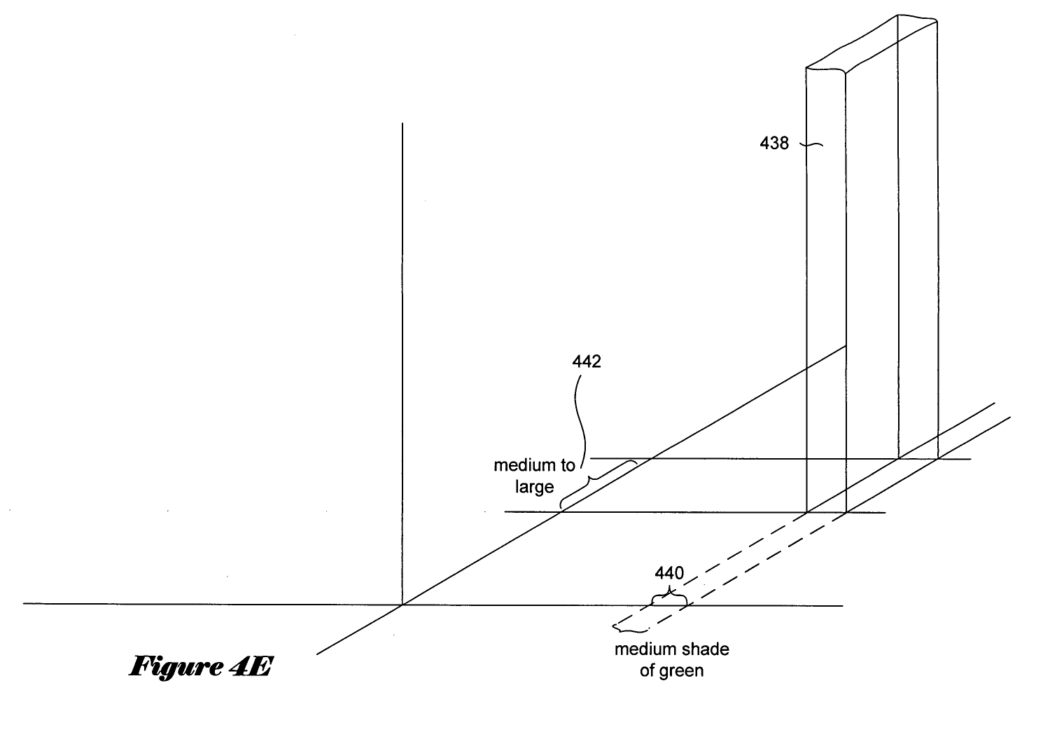

FIG. 3 illustrates an exemplary data object and an exemplary user profile employed in certain embodiments of the present invention. In the case of a photographic-image data-object library, a separate data object may be used to represent each photographic image. In certain systems, the data object 302 may include a binary-encoded photographic image 304, often in a compressed form, as well as a list of attribute/attribute-value pairs 306 that describe the photographic image. In many systems, the attribute/attribute-value pairs may be separately stored from the binary-encoded photographic image, and related to the image through a file name, data-object identifier, or other such digitally encoded reference. In addition to attribute/attribute-value pairs, the contents of a photographic-image data object may be characterizable by application of some number of functions 308 generally provided by the data-object database. For example, a photographic-image database may provide functions to allow a user to determine the distribution of various types of colors within the photographic image, to carry out various image-processing and image-characterization methods, such as edge detection, ellipse detection, or that are either blue, red, or a combination of blue and red. Thus, although, for illustration clarity, all sub-populations discussed with reference to FIGS. 4A-E are described by a single sub-volume in 3-dimensional data-object space, most common sub-populations would be fined by many, and often a great many unconnected sub-volumes.

FIG. 4A shows an exemplary 3-dimensional data-object space. One or more data objects may be described by any given point within the 3-dimensional volume defined by the ranges of possible values for attributes corresponding to each dimension. In the example of FIGS. 4A-E, a first dimension, represented by a first axis 402, corresponds to the color of an object, and ranges from red 404 to blue 406. A second dimension, represented by a second axis 408, corresponds to the size of an object, and ranges from small 410 to big 412. A third dimension, represented by a third axis 414, represents the time elapsed since the object was viewed or accessed by a user. The elapsed time ranges from zero, or just viewed, 416 to viewed a very long time ago 418. A data object may be characterized by a combination of color, size, and elapsed time since viewed. For example, one or more data objects may be characterized by the point 420 in the 3-dimensional data-object space that represents an object that is exactly medium green in color, exactly medium sized, and last viewed 13½ months ago.

FIG. 4B illustrates a sub-volume of 3-dimensional data-object space. In FIG. 3, a subset or sub-population of data objects within the total population of data objects in a data library is represented by a small sub-volume 422 of the 3-dimensional data-object space. Each object described by a data object within this subset of data objects is characterized as having a color within a range of colors 422 that can be described as a medium shade of green, having a range of sizes 424 that can be characterized as from medium to large, and having been last viewed at least a year ago, but not more than 14 months ago 426. Thus, by relaxing the constraints presented by the values and attributes used to characterize the object, or, in other words, employing ranges rather than exact values for the attributes, a sub-volume of 3-dimensional data-object space that may potentially describe many more data objects is obtained. Of course, the 3-dimensional data-object space may not be uniformly detection of sub-images that may correspond to images of particular types of objects or people, and other such functions. A user profile 310 may include a variety of fields 312 that encode general characteristics and preferences of a particular user, as well as lists or sets of function/function-value pairs 314, attribute/attribute-value pairs 316, and other digitally-encoded data that describe currently formulated criteria for searching for data objects within the data-object library.

Exact details of data objects and user profiles depend on the specific implementations and capabilities of the various computer systems for which the grazing routine or grazing system is implemented. The exemplary data object and user profile shown in FIG. 3 are meant to illustrate one possible family of implementations, rather than inclusively describe or define a possible range of data objects and user profiles.

FIGS. 4A-E illustrate multi-dimensional data-object spaces and multi-dimensional-data-object-space searching. FIGS. 4A-E employ a 3-dimensional attribute-based data-object space as an exemplary multi-dimensional data-object space, for ease of illustration, but the dimensionality of data-object spaces used to represent the contents of large data-object libraries for which the method and system embodiments of the present invention are particularly useful may be very large, from tens to hundreds of dimensions, and larger numbers of dimensions. However, the present invention can also be used for one-dimensional and two-dimensional data-object spaces.

In the examples of FIGS. 4A-E, the sub-volumes describing sub-populations of data objects are shown as single compact volumes, although, in most cases, a sub-population is described by multiple unconnected sub-volumes. In the examples below, one dimension of the 3-dimensional data-object space is defined by a color attribute. Although all of the illustrated sub-population-defining sub-volumes involve a single point or segment of the color axis, many sub-populations that would naturally arise in typical searching and directed browsing of data objects involve multiple points and line segments of the color axis, and would therefore be described by multiple unconnected sub-volumes within 3-dimensional data-object space. For example, a sub-population might be partially or completely defined as all data objects populated, so a large sub-volume may not necessarily describe more data objects in the total population than a smaller sub-volume. However, for the purposes of the current discussion, the volume of a sub-space may be regarded as generally proportional to the number of data objects characterized by the attribute values that define the sub-volume.

FIG. 4C shows an even larger sub-volume of the 3-dimensional data-object space shown in FIG. 4A. The attribute-value ranges have been expanded, in FIG. 4C, to: (1) a color between yellow and green 428; (2) a size between not small and not very large 430; and (3) an elapsed time since previous viewing from between 0 and 2 years 432. The larger sub-volume shown in FIG. 4C potentially describes a much larger number of data objects than the small sub-volume shown in FIG. 4B.

FIG. 4D shows a sub-volume of the 3-dimensional data-object volume shown in FIG. 4A characterized by a single range of values for a single dimension. The sub-volume 434 can be described as representing all data objects having a range of colors characterized as a medium shade of green 436. The size and elapsed time since viewing are not specified. Therefore, the sub-volume is a slice of the 3-dimensional data-object volume perpendicular to the color axis. FIG. 4E shows a sub-volume of the 3-dimensional data-object volume shown in FIG. 4A obtained when value ranges for two of three attributes are specified. The sub-volume 438 shown in FIG. 4E corresponds to data objects with a range of colors characterized as a medium shade of green 440 and a range of sizes 442 characterized as from medium to large. The sub-volume 438 is unbounded in the positive, elapsed-time-since-viewing direction, since no elapsed time since viewing is specified.

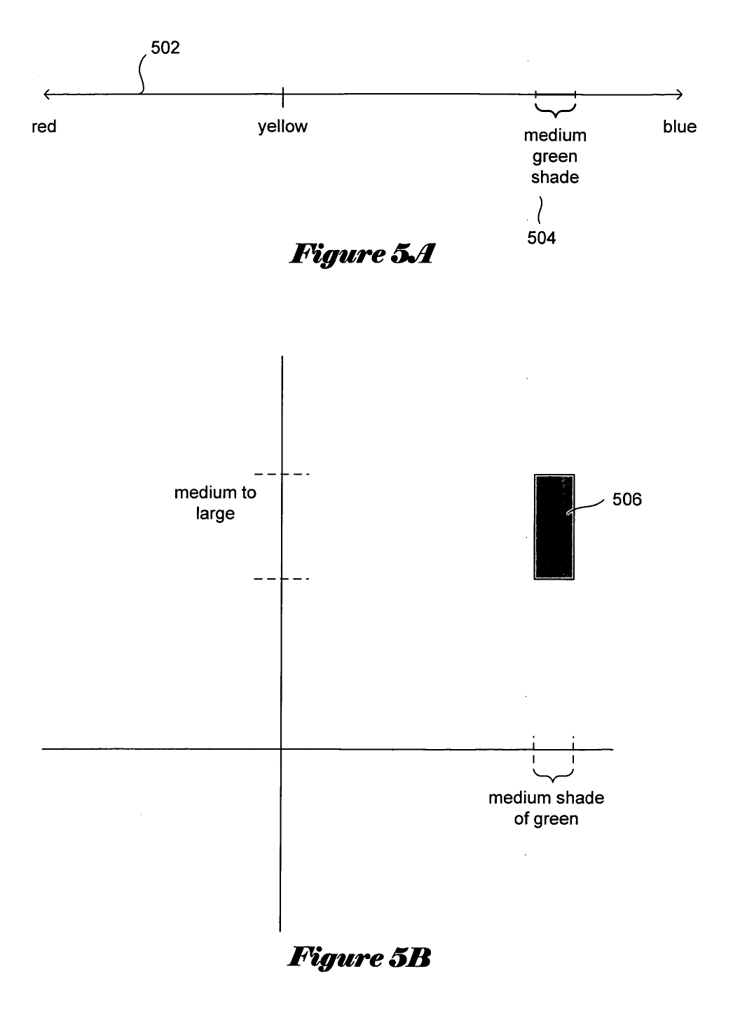

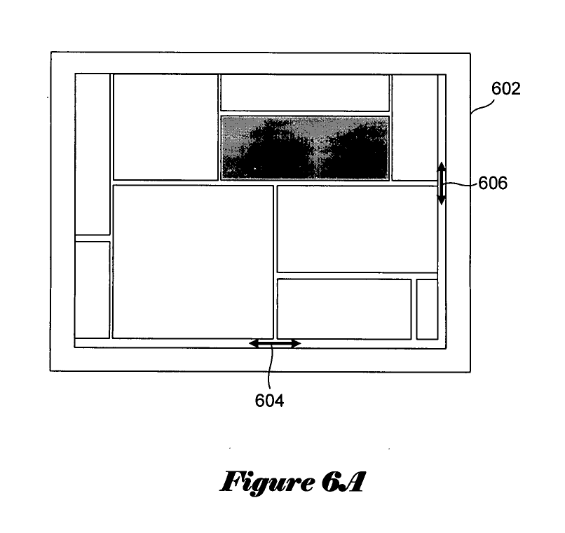

FIGS. 5A-B illustrates 1-dimensional and 2-dimensional projections of the 3-dimensional sub-volume illustrated in FIG. 4D. FIG. 5A illustrates the sub-volume illustrated in FIG. 4D projected onto a single color axis 502. When the value of only a single dimension is specified, the total number of data-object-describing points can be considered to be projected onto the axis representing that dimension. The data objects described by the sub-volume 434 illustrated in FIG. 4D correspond to the line segment 504 of the color axis that describes colors characterized as medium shades of green. Similarly, when only two of the three attribute dimensions are specified, the 3-dimensional data-object space shown in FIG. 4A can be projected onto a plane containing the two axes, or dimensions, for which values are specified. FIG. 5B shows the sub-volume 438 in FIG. 4E projected onto the size/color plane containing the size and color axes of the three-dimensional data-object space. The sub-volume 438 is projected onto a rectangular area 506 in the 2-dimensional projection corresponding to objects with colors characterized as medium shades of green and objects that are from medium to large size.

For purposes of the current discussion, the size of the data-object library may be considered to fixed, although, in most common implementations, the number of data objects stored within the data-object library may continuously change as data objects are added and deleted. Because the number of data objects in a data-object library is essentially fixed, the density of data objects described by an r-dimensional sub-volume of an r-dimensional subspace of an n-dimensional data-object space is potentially much higher than the density of data objects described by an equivalent n-dimensional subspace of the n-dimensional data-object space. For example, considering FIGS. 4E and 5B, the same number of data objects that are described by the 3-dimensional sub-volume 438 of the three-dimensional data object space shown in FIG. 4E are described by the 2-dimensional area 506 of the 2-dimensional data-object space shown in FIG. 5B. A group of data objects can therefore be more precisely defined using three attribute values for the three possible dimensions than by using two attribute values for two of the three dimensions or one attribute value for one dimension, since a small, precisely defined 3-dimensional sub-volume of the sub-volume 438 in FIG. 4E can generally be expected to describe far fewer data objects than an equivalently precisely defined sub-area of the 2-dimensional area 506 of a 2-dimensional data-object-space projection and far more precisely than an equivalently precisely defined sub-segment of the line segment 504 in the 1-dimensional projection of the data-object space. In conducting searches for data objects within an n-dimensional data-object space, as more attribute values for more attributes are specified, the number of data objects described by the total number of specified attribute/attribute-value pairs dramatically decreases. Adding an attribute value for a single additional dimension in a high-dimensional space may decrease the number of data objects characterized by a factor of from ten to hundreds, thousands, millions, or more. Thus, a search for data objects usually involves both specifying values or ranges of values for an increasing number of attributes, as well as narrowing attribute-value ranges specified for the attributes.

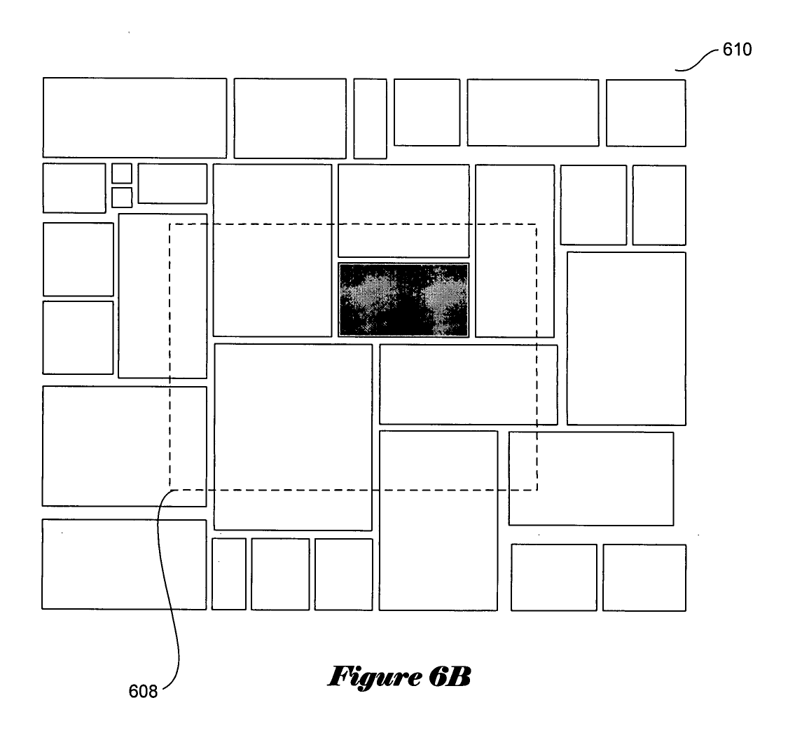

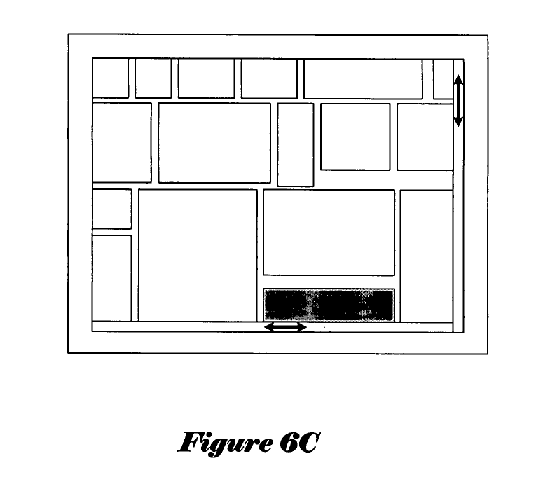

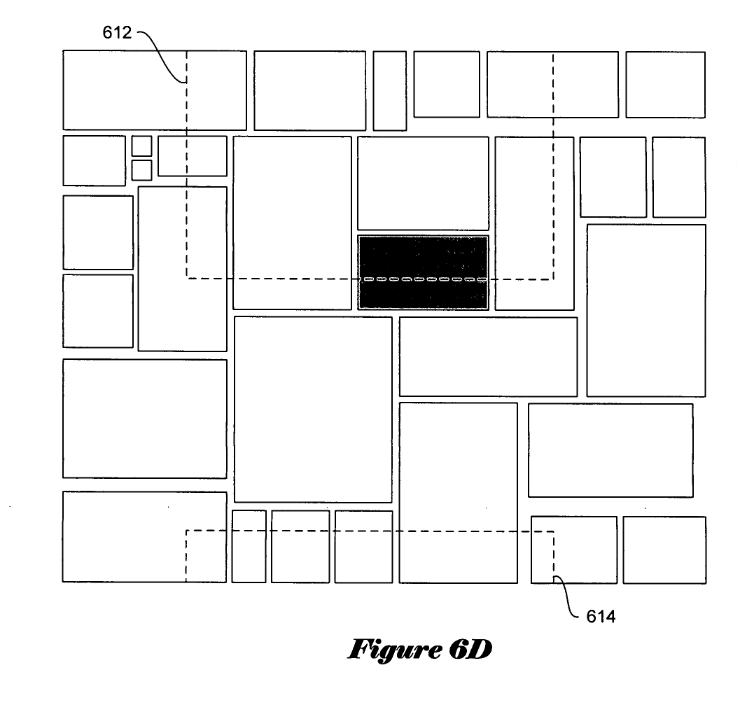

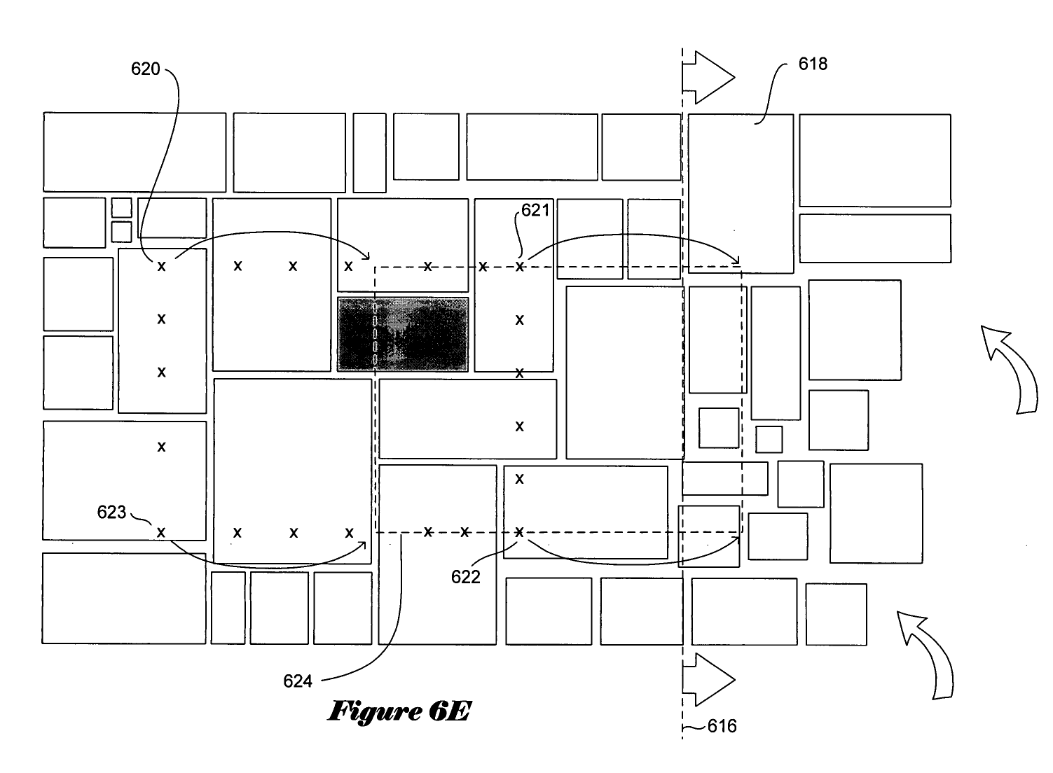

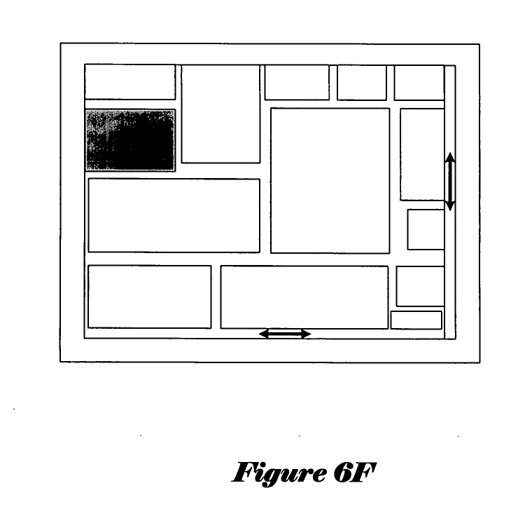

FIGS. 6A-F illustrate a photographic-image data-object presentation used in various photographic-image-based embodiments of the present invention. This same type of presentation may also be used for documents, video clips, and other readily visually displayable data-object types. FIG. 6A illustrates a computer monitor 602 on which a number of photographic images, represented by rectangles, are displayed. The presentation provides scrolling features 604 and 606 to allow the user to scroll horizontally and vertically, respectively, across a greater, logical photographic-image-displaying area. FIG. 6B illustrates the logical photographic-image-display area from which sub-areas are selected for display by the presentation routine. As shown in FIG. 6B, the area that can be displayed by the display monitor 608, shown in FIG. 6B as a rectangle of dashed lines, is smaller than the total abstract area of the logical photographic-image-display area 610. Using the scrolling features, a human user may move the display rectangle 608 horizontally and vertically over the logical photographic-image display area 610. For example, FIG. 6C shows a display selected from the logical photographic-image display area (610 in FIG. 6B) by scrolling vertically upward with respect to the display shown in FIG. 6A. As shown in FIG. 6D, the display window 612 has been moved vertically upward and wrapped over to the bottom portion 614 of the logical photographic-image display area, so that the logical photographic-image display area is essentially borderless in the vertical dimension. The logical photographic-image display area may be electronically represented by one or more coordinate pairs associated with each photographic image in a list of photographic images. The presentation may also provide features for scaling, rotation, and other standard image-altering commands.

In addition to user-input-directed scrolling, the presentation routine may provide tunable scrolling parameters, remote-procedure-call-based scrolling, or other means for controlling scrolling by the grazing routine, so that the grazing routine can scroll the display window in order to automatically present a well-distributed data-object sample set to a user. In addition, automated scrolling may be carried out by the presentation routine, independently, so that, without user direction, all data objects within the logical display area are displayed as the display window is scrolled automatically to provide a continuously changing display.

The presentation routine used in many embodiments of the present invention continuously appends new data objects to one edge of the logical data-object display area, and correspondingly and automatically translates the display window towards the edge to which new data-objects are appended. FIG. 6E illustrates the data-object appending process. In FIG. 6E, the previous right-hand edge of the logical photographic-image display area shown in FIGS. 6B and 6D is indicated by a dashed, vertical line 616. New data objects, such as data object 618, have been appended to the logical data-object display area by the presentation routine in a continuous fashion. Similarly, the display window has been translated rightward towards the edge of the logical display area to which new data objects are appended 616. The previously shown location of the display window included corners 620-623, shown by small “x” characters in FIG. 6E. Over time, the display window has been shifted rightward to the new location indicated by the rectangle of dashed lines 624. FIG. 6F shows display of the contents of the relocated display window 624. Presentation routines used in embodiments of the present invention continuously shift the display window rightward at a rate equivalent to the rate at which new display data-objects are added to the logical photographic-image display window so that a human user views a continuously scrolling display of photographic images.

In various embodiments of the present invention, the grazing routine continuously selects data objects from a current sub-population of data objects within a data-object library. The current sub-population is generally defined by previous user input or automatic constraint-relaxing functionality of the grazing routine, described below. In general, user input tends to continuously decrease the current sub-population size as user input adds attributes and attribute values to the criteria by which the sub-population is defined during data-object searches. The sub-population is a reflection of the inferences that can be drawn from user input as to the data-objects that are of current interest to the user. For example, attributes of a selected data object may be added to the current criteria that define the current sub-population of data objects from which data objects are selected for presentation. Data objects selected from the current sub-population are input to the presentation routine for appending to the logical data-object display area, so that, as the user continues to watch the displayed data objects scrolling across the user's display, and as the user inputs additional selections, the currently displayed data objects are of increasing interest to the user. A user may efficiently search the data-object library to locate one or a small number of data objects by steering the selection and display of data objects by the grazing routine.

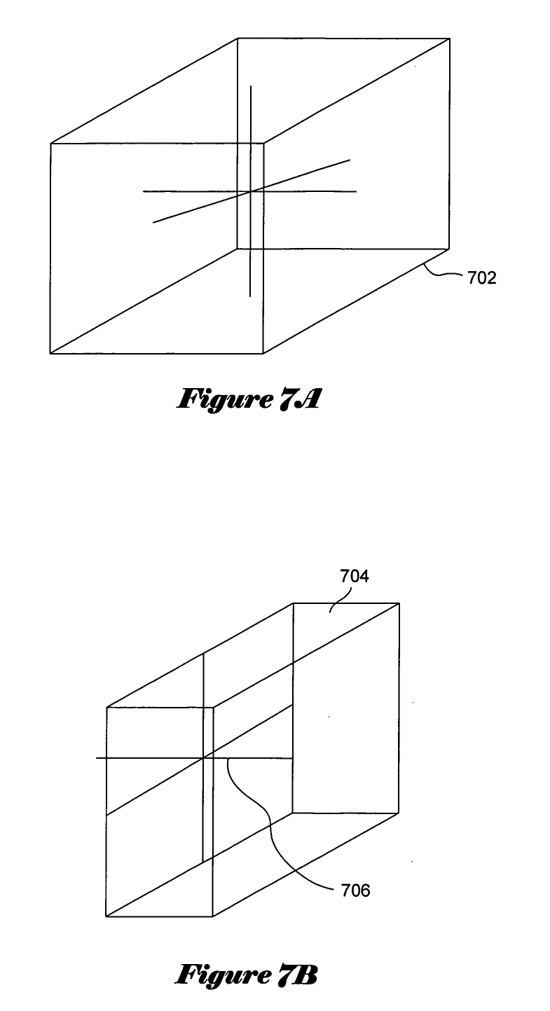

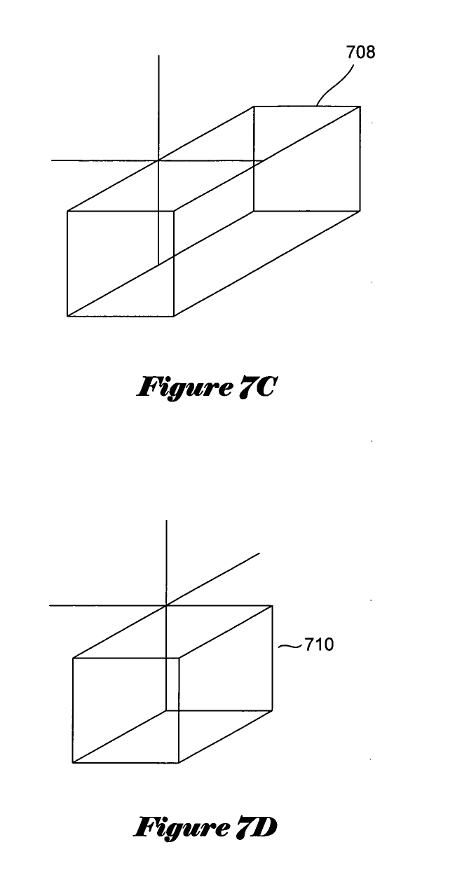

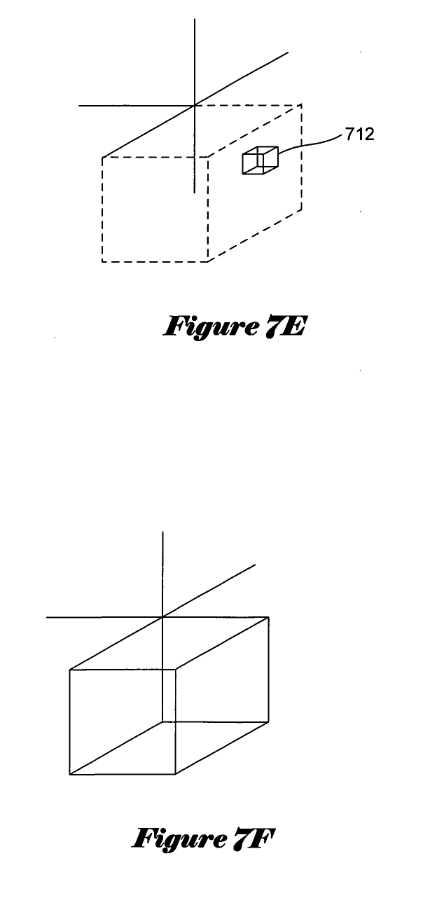

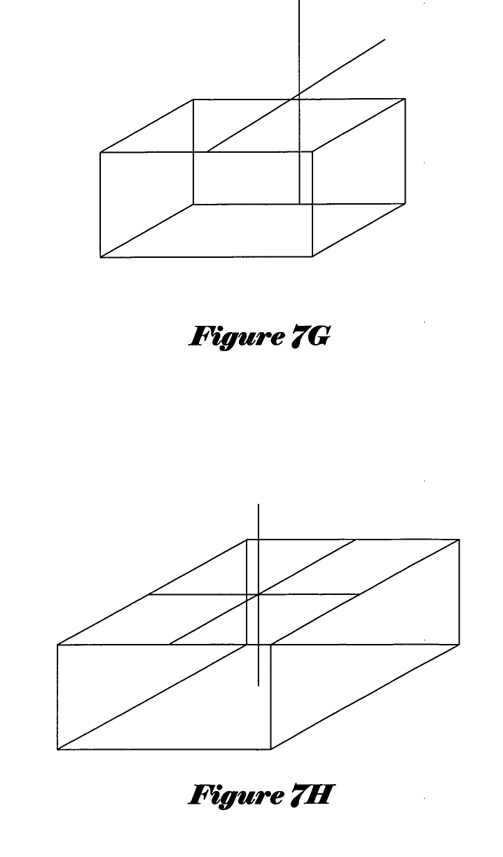

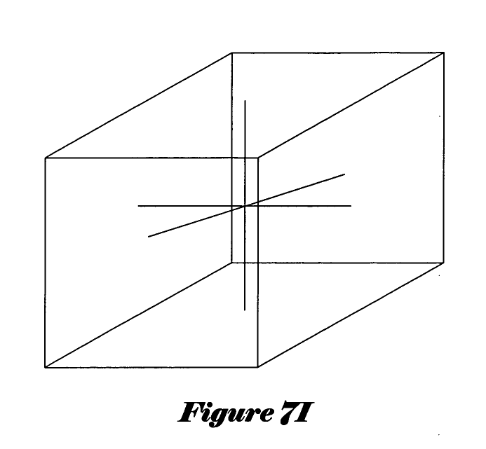

When the user fails to input additional selections or criteria for a period of time, a grazing routine relaxes the current criteria-defined sub-population, resulting in the current sub-population increasing in volume back towards the volume that encompasses the entire population of data objects within the data library. FIGS. 7A-I illustrate changes in a current sub-population resulting from user input and from automatic data-object-selection-criteria relaxation due to user inactivity according to various embodiments of the present invention. FIG. 7A shows an initial starting point represented by a volume 702 in 3-dimensional data-object space that includes all of the 3-dimensional-data-object-space points corresponding to data objects within a data library. Initially, the grazing routine selects data objects represented by points from throughout the initial volume 702 for input to the presentation routine, which displays the selected data objects in a continuing, scrolling fashion as described above with reference to FIGS. 6A-F. If a user inputs a mouse click, or provides some other input, to express interest in a particular displayed image, the grazing routine may use attributes that characterize the user-selected image to update the user's profile that defines the current sub-population. Thus, as shown in FIG. 7B, user selection of an image has resulted in the sub-population shrinking from data objects described by points in the entire 3-dimensional volume shown in FIG. 702 to points in one-half of the volume 704 that includes the positive first axis 706. Additional user selections or input successively shrinks the sub-population to those data objects described by points in sub-volumes one-quarter the size 708, as shown in FIG. 7C, and one-eighth the original size 710, as shown in FIG. 7D. Finally, as shown in FIG. 7E, additional user input has resulted in a current sub-population of data objects, described by points within a small sub-volume 712, that contains only a very small fraction of the data objects within the data-object library. Should the user fail to provide additional input, the grazing routine slowly relaxes the constraints stored in the user's profile. Thus, the small selected sub-volume 712 is successively expanded, by the grazing routine, to ever-larger sub-volumes of the 3-dimensional data-object space as illustrated in FIGS. 7F-H. If the user fails to again interact with the presentation routine, then the current sub-population finally increases back to the entire population of data objects within the data-object library, as shown in FIG. 7I. Although the sub-population-describing sub-volumes are shown as increasing or decreasing by a factor of 2 in FIGS. 7A-I, the actual factor may be 10, 100, or greater in high-dimensional data-object spaces, and may be controllable as a grazing-routine parameter.

The grazing routine may select data objects from the current sub-population for presentation by a variety of different techniques. The data objects may be selected randomly, sequentially, or in some structured fashion to, for example, eventually present all data objects within the sub-population, present a subset of data objects representative of the sub-population, present data objects most often viewed or displayed, display data objects nearest the center in n-dimensional space of the selected population, or by other criteria. Data objects may not necessarily be evenly distributed within sub-volumes of n-dimensional space, or evenly distributed across nodes of hierarchical data-object classifications, and therefore data-object selection methods may need to estimate or ascertain the actual distribution of data objects in order to select representative data objects over a period of time.

Although a Cartesian, n-dimensional data-object space is a convenient representation of the sub-population selection method employed in various embodiments of the present invention, other representations are possible. FIG. 8 shows a hierarchical classification scheme by which data objects may be classified. In FIG. 8, a root node 802 represents an entire population of data objects within a data-object library. When a particular selection is made, represented by arrow 804 in FIG. 8, a sub-population of data objects, represented by node 806, is obtained that encompasses a much smaller number of data objects than encompassed by the root node 802. Specification of an additional attribute, or selection of a particular image from the sub-population of images represented by node 806, may result in a still smaller sub-population represented by node 808, with the transition from node 806 to node 808 represented by arrow 810. Relaxation of the constraints that define the sub-population, represented by arrow 812, moves the current sub-population back upward in the hierarchy to a higher-level node. The cones in FIG. 8, such as cone 814 emanating from node 816, represent subtrees below the lowest level of nodes shown in FIG. 8. In such representations, any particular node may have as many links emanating from the node to lower-level nodes as there are possible different selections based on the current sub-population represented by the node.

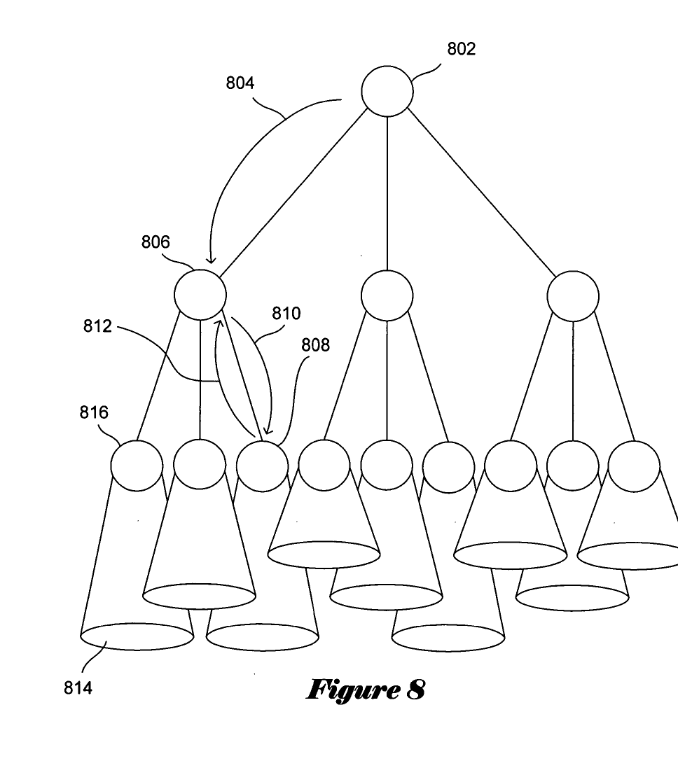

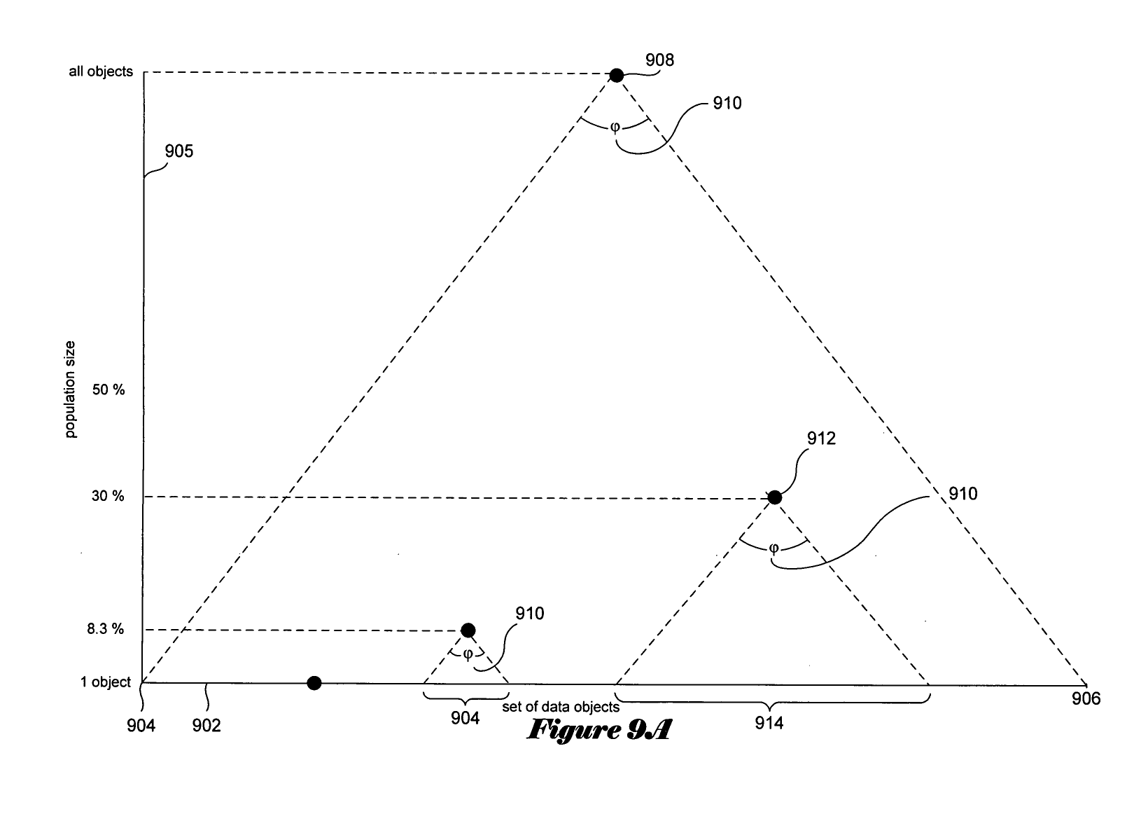

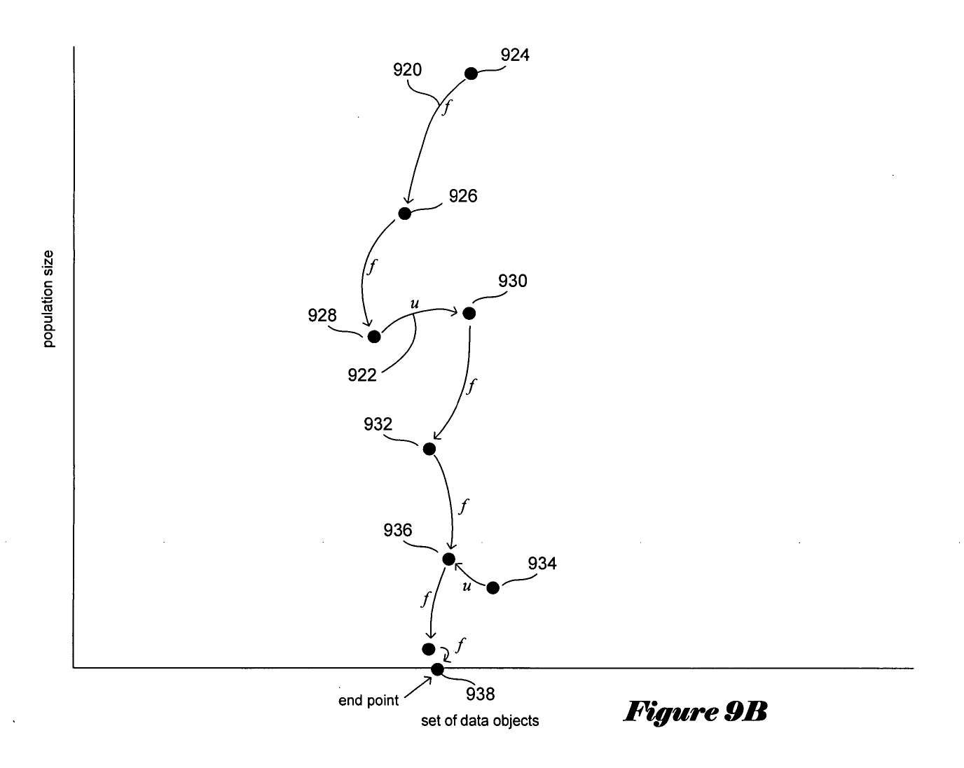

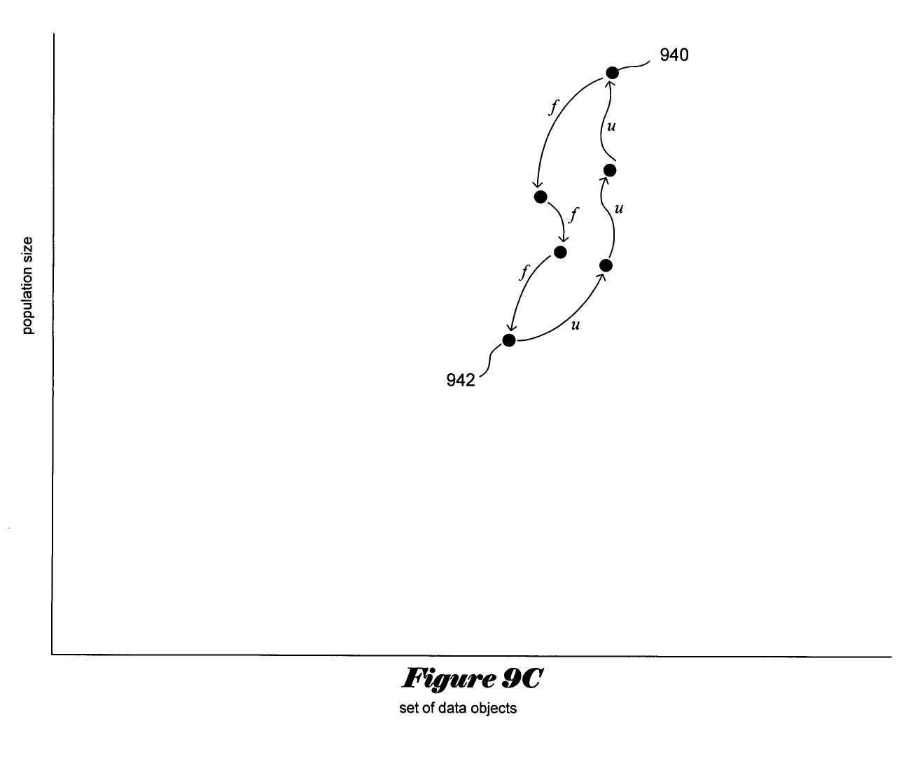

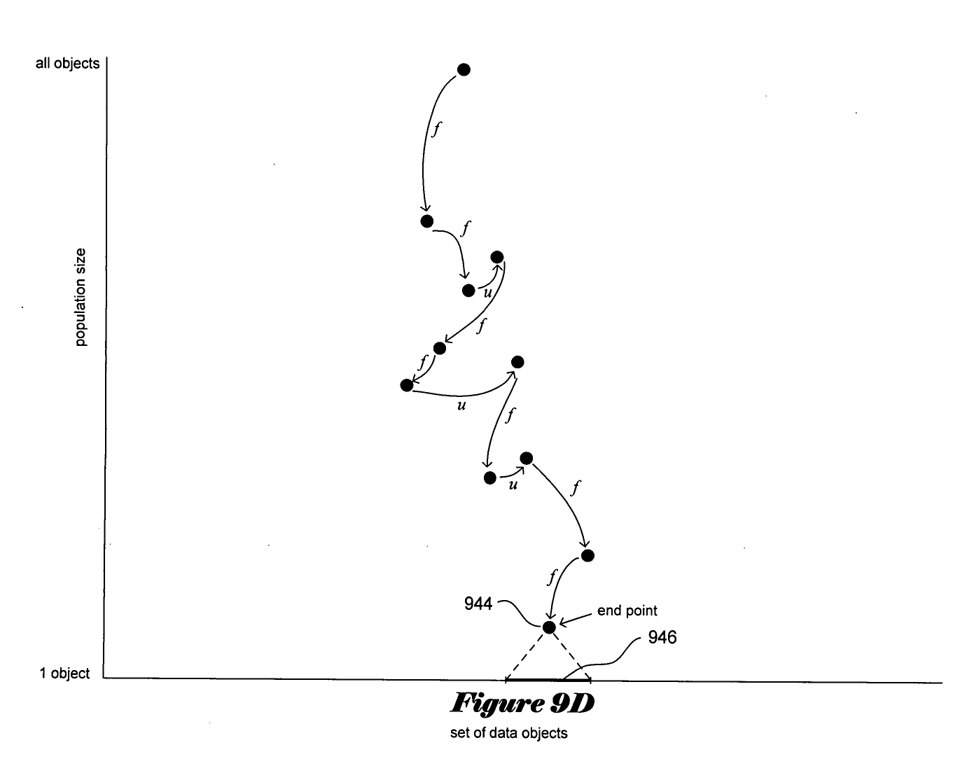

FIGS. 9A-D illustrate typical user searches conducted by using various embodiments of the present invention. In FIG. 9A, the space of possible directed searches of a population of data objects within a data-object library is represented as a 2-dimensional plane. The first dimension, represented by axis 902, includes all of the data objects within the data-object library. Line segments along the axis represent sub-populations of the data objects. For example, the line segment 904 represents a sub-population of data objects within the total population of data objects represented by the line segment from the origin 904 to point 906. The second dimension, represented by a second axis 905, corresponds to the sub-population size, or to a percentage of data objects in a sub-population with respect to the total population size. Points on the 2-dimensional plane, such as point 908, represent search states. For example, point 908 is a convenient starting search state in which all data objects within a data-object library are contained within the current sub-population, or in which the current sub-population equals the total population. The current sub-population for a particular point, or search state, is represented by the line segment on the first axis subtended by a fixed angle φ 910. For example, in search state 912, line segment 914 represents the ratio of the sub-population considered in search state 912 to the total population, or total size of the data-object library. Thus, as search states more closely approach the first axis 902, the sub-populations from which data objects are selected in the search state grow increasingly smaller. Of course, the data-objects are not actually sequentially ordered with respect to the first axis 902, but may occur in different orders depending on the criteria that define particular search states.

FIG. 9B illustrates a typical search that may be carried out by a user of various method and system embodiments of the present invention. Downward transitions represented by curved arrows labeled “f,” such as arrow 920, represent forced transitions in which a user inputs a data-object selection or other input that results in narrowing of the current sub-population size, and upward-pointing curved arrows labeled “u,” such as arrow 922, represent unforced transitions in which the grazing routine, due to user inactivity, automatically expands the current sub-population size by relaxing the criteria by which the current sub-population is defined. Initially, the search begins at a starting point 924. As the grazing routine selects data objects for display from the current sub-population, and as the user inputs selections or other types of input, forced transitions carry the search downward to search states 926 and 928 with ever-decreasing sub-population sizes. A period of user inactivity may result in an unforced transition 922 to a search state 930 with a somewhat larger sub-population size, from which additional user input leads, through forced transitions, to subsequent search states 932 and 934 with decreasing sub-population sizes. Another period of user inactivity may lead to a slight, automatic increase in sub-population size at search state 936, and additional user input may lead through forced transitions to a final end point 938 representing a single data object.

Although, for searching tasks, forced transitions are often to considered to decrease the size of the current sub-population from which data objects are selected for presentation, user input may also, in various embodiments, increase sub-population size or have no effect on sub-population, but instead change the data-objects within the sub-population by changing the criteria that define the sub-population to select a different, equally populated sub-volume from n-dimensional data-object space. User input may even fix the current sub-population for some period of time, to disable unforced transitions.

As shown in FIG. 9C, searches may not necessarily lead to results. In the search shown in FIG. 9C, three forced transitions lead from a starting point 940 to an intermediate point 942 at which this current sub-population has been significantly narrowed. However, because of user inactivity, unforced transitions lead back to the initial starting point 940. As shown in FIG. 9D, a search may not lead to a single data object, but may instead lead to an end point 944 at which the current sub-population includes a set of data objects represented by line segment 946 in FIG. 9D. Similarly, starting points need not be search states that encompass the entire population of data objects, but may instead encompass only a portion of the data objects according to certain pre-defined or inferred user preferences based on past user behavior. Once a user has found one or a set of desired data objects, the user may print the data objects, store the data objects in directories, input the data objects to any of various application programs, or otherwise use the data objects by additional, non-navigational input.

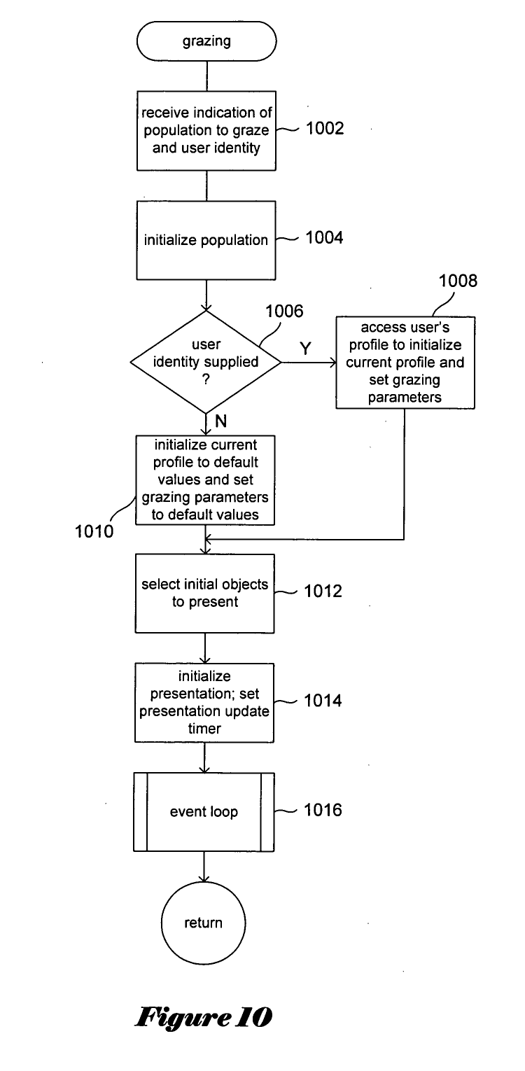

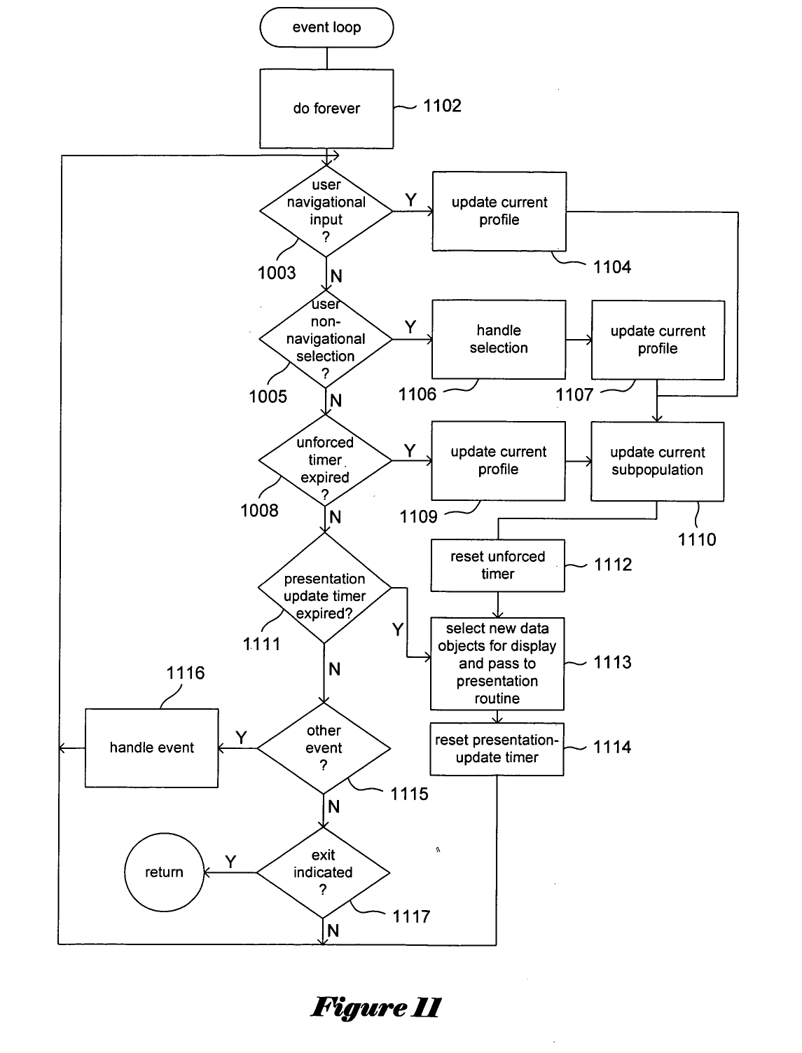

FIGS. 10-11 provide control-flow diagrams for a grazing routine that represents one embodiment of the present invention. As shown in FIG. 10, the grazing routine, in step 1002, receives an indication of the data-object library, or population, that is to be grazed, or browsed and searched, by a user, as well as an individuation of the user's identity. In step 1004, the grazing routine initializes the population of data objects. If a valid user identity was supplied in step 1002, as determined in step 1006, then the user's profile is accessed and a current profile is initialized based on the user's profile in step 1008. Otherwise, default values are used to initialize the current profile in step 1010. In addition to initializing the current profile, various grazing-application parameters and characteristics can be set and defined according either to values residing in a user's profile or default values in steps 1008 and 1010. Next, in step 1012, the grazing routine selects an initial starting point for the search, selects an initial sub-population corresponding to the starting point, and selects an initial set of data objects from the current sub-population for presentation to the presentation routine. In step 1014, the grazing routine initializes the presentation routine, inputting the data objects selected in step 1012, and sets a presentation-update timer to a desired presentation-update time interval. Finally, in step 1016, the grazing routine enters a continuously iterating event loop.

FIG. 11 shows the grazing-application event loop. The grazing-application event loop is a do-forever loop comprising steps 1102-1117 that continuously iterates until an exit condition arises. In each iteration of the do-forever loop, the grazing-application event loop determines, in step 1103, whether the user has input a navigational input, such as a data-object selection input. If so, then the event loop updates the current profile, in step 1104, updates the current sub-population based on the updated profile in step 1110, resets an unforced-transition timer, in step 1112, selects data objects from the new current sub-population for presentation to the presentation routine, in step 1113, and resets the presentation-update timer to a desired interval for adding new data objects in step 1114.

The unforced-transition timer is set, in step 1112, to the minimum time of user inactivity for generating an automatic data-object sub-population expansion, as discussed above. In step 113, the data objects are selected by any of various types of selection methods, as discussed above, and are passed to the presentation routine to allow the presentation routine to schedule addition of the selected data objects to the logical presentation display area for eventual display and viewing by a user. In certain embodiments, the grazing routine may command the presentation routine to add data objects and translate the display window, while, in alternative embodiments, the presentation routine may run asynchronously, and update the logical presentation display area, translate the display window, and arrange for rendering of the contents of the display window by a display or presentation device according to internal presentation-routine parameters and timers.

When the event loop determines that a non-navigational user input or selection has been input, in step 1105, then the event loop invokes a handler appropriate for the input or selection, in step 1106, updates the current profile, if necessary, in step 1107, updates the current sub-population, selects data objects from the current sub-population, and resets the unforced and presentation-update timers in steps 1110-1114. If, as determined in step 1108, the event loop determines that the unforced-transition timer has expired, then, in step 1109, the event loop updates the current profile to relax the criteria by which the current sub-population is defined, updates the current sub-population in step 1110 according to the new constraints, resets the unforced-transition timer, in step 1112, selects data objects from the new current sub-population for presentation to the presentation routine, in step 1113, and resets the presentation-update timer to a desired interval for adding new data objects in step 1114. If, on the other hand, the event loop determines that the presentation-update timer has expired, as determined in step 1111, then the event loop selects new data objects from the current sub-population, in step 1113, and resets the presentation-update timer in step 1114. If the event loop determines that some other event has occurred, in step 1115, then an event handler appropriate for that event is called, in step 1116. Finally, if the event loop determines that an event that should cause the event loop to terminate has occurred, in step 1117, then the event loop terminates.

Although the present invention has been described in terms of particular embodiments, it is not intended that the invention be limited to these embodiments. Modifications within the spirit of the invention will be apparent to those skilled in the art. For example, an essentially limitless number of different possible grazing-routine and presentation-routine implementations are possible, using any of a large variety of different programming languages, implementing the routines for various hardware and operating-system platforms, and using a variety of different modular organizations, control primitives, data structures, variable declarations, and other such programming parameters. The grazing routine and presentation routine may be incorporated into a large number of different types of software applications and systems. In particular, the criteria for sub-population definition that are refined by user input to narrow the sub-population to encompass data-objects desired by a user may vary from system to system, depending on the access, characterization, and search primitives provided by the data-object library or data-object database. Criteria may include function/function-argument/function-value triples, attribute/attribute-value pairs, full or partially formed queries, set expressions, Boolean expressions, executable search routines, and other such information that can be used in various systems to access, characterize, and search for data objects. The grazing routine may use any of a large variety of sampling techniques for selecting data objects from the current sub-population, including random selection, selection according to pre-defined sampling strategies or distributions, and other techniques. As discussed above, a user may employ any of a variety of non-navigational input commands to direct located data objects to other applications, to a printer, to an object-display routine, to local or remote storages, and to other such utilities and procedures. Presentations routines may present any number of different types of data objects to a user using many different presentation strategies and techniques appropriate to the type of data objects stored in the data-object library. The present invention may be applied to searching and directed browsing of many different types of data-objects and data-object libraries. For example, a movie database might be browsed by an embodiment of the present invention. Still images from movies may be displayed, which, when selected by a user, might result in display of short, video segments selected from the movie. Movies may be described by a very large number of different attributes, from the names of principle actors and actresses to date of release, subject matter, commercial success, critical reviewer's ratings, and any number of additional attributes. In the above-described embodiments, data-object-characterizing criteria are automatically relaxed following a period of time without user input, but criteria relaxation may be triggered instead by display of a threshold number of data objects without user inputs, or may be triggered by other considerations or events.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A data-object-searching-and-perusal system comprising:
data objects contained in a data-object library that provides data-object-access facilities that locate data objects based on data-object-access criteria;
a presentation routine that electronically presents data-objects; and
a grazing routine that
continuously selects data objects from a current sub-population of data objects defined by current data-object-access criteria for input to the presentation routine for presentation, receives user input that modifies the current data-object-access criteria, in turn modifying the current sub-population from which data-objects are selected for presentation, and
automatically relaxes data-object-access criteria during periods without input, to expand the current sub-population of data objects from which data objects are selected for presentation.

2. The data-object-searching-and-perusal system of claim 1 wherein data objects may include:
photographic images;
digitally-encoded video signals;
digitally encoded audio signals;
multi-media presentations;
text and graphics-containing documents; and
data files renderable by an application program.

3. The data-object-searching-and-perusal system of claim 1 wherein the presentation routine provides a logical data-object display from which display windows can be selected by a user.

4. The data-object-searching-and-perusal system of claim 3 wherein the presentation routine adds data objects, received at intervals from the grazing routine, to the logical data-object display and correspondingly translates the display window within the logical data-object display to present a continuously updated display.

5. The data-object-searching-and-perusal system of claim 4 wherein the presentation routine translates the display window in both horizontal and vertical directions in order to present all the data objects within the logical data-object display while presenting a continuously updated display.

6. The data-object-searching-and-perusal system of claim 1 wherein data-object-access criteria may include one or more of:
attribute/attribute-value pairs;
function/function-arguments/function-output-value triples;
partially or completely formulated data-object-selection queries;
Boolean expressions;
set expressions;
relational-algebra expressions;
database queries; and
executable routines.

7. The data-object-searching-and-perusal system of claim 1
wherein input-based data-object-access-criteria modification, referred to as forced transitions, allow a user to steer data-object presentation to sub-populations of data objects of interest to the user; and
wherein grazing-routine relaxation of data-object-access-criteria, referred to as unforced transitions, provide for automatic sub-population expansion to facilitate user searching and browsing of the entire data-object library.

8. The data-object-searching-and-perusal system of claim 1 wherein the grazing routine continuously selects data objects from a current sub-population of data objects defined by current data-object-access criteria for input to the presentation routine for presentation by one or more of:
randomly selecting data objects from the current sub-population of data objects;
selecting data objects from the current sub-population of data objects by fairly sampling the data objects according to an estimated or ascertained distribution;
selecting the data objects from the current sub-population of data objects in order to eventually present all data objects within the sub-population;
selecting a subset of data objects determined to be representative of the sub-population;
selecting data objects most often selected by users; and
selecting data objects nearest the center of the sub-population n n-dimensional space.

9. The data-object-searching-and-perusal system of claim 1 wherein a user may select a presented data object, by inputting a selection indication to the presented data object, for one or more of:
inputting the selected data object to a data-object-receiving application program;
printing or otherwise recording the data object;
storing the data object in electronic memory;
storing the data object on a mass storage device; and
observing the data object.

10. The data-object-searching-and-perusal system of claim 1 wherein the current data-object-access criteria are stored within a current profile that includes preferences and encoded characteristics of a user.

11. A method for searching or browsing data objects within a data-object library, the method comprising:
initializing a current sub-population of data objects selected from the data-object library and defined by current data-object-selection criteria; and
iteratively,
selecting data objects from the current sub-population,
presenting the selected data objects, and
modifying the current data-object-selection criteria in order to modify the current sub-population of data objects from which data objects are subsequently selected for presentation, the modification elicited by input and automatically, by the grazing routine, following a period without input.

12. The method of claim 11 wherein the current data-object-selection criteria are stored within a current profile that includes preferences and encoded characteristics of a user.

13. The method of claim 11 wherein selecting data objects from the current sub-population further includes one or more of:
randomly selecting data objects from the current sub-population of data objects;
selecting data objects from the current sub-population of data objects by fairly sampling the data objects according to an estimated or ascertained distribution;
selecting the data objects from the current sub-population of data objects in order to eventually present all data objects within the sub-population;
selecting a subset of data objects determined to be representative of the sub-population;
selecting data objects most often selected by users; and
selecting data objects nearest the center of the sub-population n n-dimensional space.

14. The method of claim 11 wherein presenting the selected data objects further includes:
adding selected data objects to a logical data-object display;
providing a display window within the logical data-object display that can be translated vertically and horizontally by user input or programmatically over the logical data-object display; and
and automatically translating the display window in the direction of newly added data objects to provide a continuously changing presentation of data objects.

15. The method of claim 11 wherein modifying the current data-object-selection criteria in order to modify the current sub-population of data objects from which data objects are subsequently selected for presentation further includes:
receiving input to a presented data object and modifying the current data-object-selection criteria to reflect the received input.

16. The method of claim 15 wherein the current data-object-selection criteria is modified to decrease the number of data objects within the current sub-population that encompasses the presented data object to which input is received.

17. The method of claim 15 wherein the current data-object-selection criteria is modified to increase the number of data objects within the current sub-population.

18. The method of claim 11 wherein modifying the current data-object-selection criteria in order to modify the current sub-population of data objects from which data objects are subsequently selected for presentation further includes:
automatically relaxing the current data-object-selection criteria to increase the number of data objects within the current sub-population following a period without user input.

19. The method of claim 11 wherein modifying the current data-object-selection criteria in order to modify the current sub-population of data objects from which data objects are subsequently selected for presentation further includes:
automatically modifying the current data-object-selection criteria to change the data objects included within the current sub-population following a period without user input.

20. The method of claim 11 wherein a presented data object may be selected, by inputting a selection indication to the presented data object, for one or more of:
inputting the selected data object to a data-object-receiving application program;
printing or otherwise recording the data object;
storing the data object in electronic memory;
storing the data object on a mass storage device; and
observing the data object.
